(19) United States
(12) Patent Application Publication
(10) Pub. No.: US 2016/0041596 A1
(43) Pub. Date: Feb. 11, 2016

(54) POWER EFFICIENT METHOD AND SYSTEM FOR EXECUTING HOST DATA PROCESSING TASKS DURING DATA RETENTION OPERATIONS IN A STORAGE DEVICE

(71) Applicant: NXGN DATA, INC., Irvine, CA (US)

(72) Inventors: Joao Alcantara, Irvine, CA (US); Ricardo Cassia, Rancho Santa Margarita, CA (US); Vincent Lazo, San Diego, CA (US); Kamyar Souri, San Jose, CA (US)

(21) Appl. No.: 14/816,981

(22) Filed: Aug. 3, 2015

Related U.S. Application Data
(60) Provisional application No. 62/034,055, filed on Aug. 6, 2014.

(51) Int. Cl. G06F 1/32; G06F 1/28

(52) U.S. Cl. CPC G06F 1/329; G06F 1/28

(57) ABSTRACT

The solution described here is a method to schedule the execution of data processing tasks while data retention operations need to be performed. The main objective of this approach is to minimize the power consumption of the host data processing tasks that are not time sensitive. The Storage Device may be in a power saving mode or even off at the time the Host wants to execute a data processing task. For non-critical data processing tasks, the Host activates the device at a specific time estimated by the drive to run data retention tasks, and then sends the data processing function to the device. The device executes the Host data processing tasks and also performs the data retention operations accordingly. After the entire process is complete, the device can return to the initial power state or any power state determined by the Host.

### CROSS-REFERENCE TO RELATED APPLICATION(S)

The present application claims priority to and the benefit of U.S. Provisional Application No. 62/034,055, filed Aug. 6, 2014, entitled “POWER EFFICIENT METHOD AND SYSTEM FOR EXECUTING HOST DATA PROCESSING TASKS DURING DATA RETENTION OPERATIONS IN A STORAGE DEVICE”, the entire content of which is incorporated herein by reference.

### FIELD

One or more aspects of embodiments according to the present invention relate to a power efficient method and system for executing host data processing tasks during data retention operations in a storage device

### BACKGROUND

Every day, several quintillion bytes of data may be created around the world. These data come from everywhere: posts to social media sites, digital pictures and videos, purchase transaction records, bank transactions, sensors used to gather data and intelligence, like weather information, cell phone GPS signal, and many others. This type of data and its vast accumulation is often referred to as “big data.” This vast amount of data eventually is stored and maintained in storage nodes, such as hard disk drives (HDDs), solid-state storage drives (SSDs), or the like, and these may reside on networks or on storage accessible via the Internet, which may be referred to as the “cloud.” In some cases the data is not accessed very frequently but it needs to be available at any time with minimal delay. For example, the data may be write once, read many (WORM), such as data posted to social media web sites, or video media posted by users on public video sharing sites.

Related art storage solutions may not be well suited to this application. Hard disk drives, for example, may consume excessive power if kept spinning, and may take too long to start up if allowed to stop after each data access. Data corruption in solid state drives might be a consequence of very long periods of idle time. This limitation is sometimes referred to as a data retention limitation. Thus, there is a need for a system and method for storing large volumes of infrequently accessed data, providing rapid access, and in a power-efficient manner. One patent application that discloses an approach to address the power efficient method to access “cold storage” data is application Ser. No. 14/093,335, but it does not describe any method to execute host data processing tasks in such condition.

Some new SSD implementations provide a mechanism to perform data processing tasks inside the storage device. For example, application Ser. No. 14/015,815 provides a mechanism to perform data processing task inside the drive, but it does not disclose a power efficient mechanism to perform the data processing tasks in WORM workloads.

### SUMMARY

Aspects of embodiments of the present disclosure are directed toward a power efficient method and system for executing host data processing tasks during data retention operations in a storage device.

### BRIEF DESCRIPTION OF THE DRAWINGS

These and other features and advantages of the present invention will be appreciated and understood with reference to the specification, claims and appended drawings wherein:

FIG. 1 is a block diagram of an SSD device in communication with a host, according to an embodiment of the present invention;

FIG. 2 is a block diagram of an intelligent SSD, according to an embodiment of the present invention;

FIG. 3 is a flow chart illustrating a mechanism to turn off the storage or command the storage device to enter a power safe mode, according to an embodiment of the present invention;

FIG. 4 is a flow chart illustrating a method and system to perform the data processing tasks in combination to the data retention operations; and

FIG. 5 is a flow chart of a server sending data processing tasks to an SSD which is responsible for managing the scheduling of the tasks, according to an embodiment of the present invention.

### DETAILED DESCRIPTION

The detailed description set forth below in connection with the appended drawings is intended as a description of exemplary embodiments of a power efficient method and system for executing host data processing tasks during data retention operations in a storage device provided in accordance with the present invention and is not intended to represent the only forms in which the present invention may be constructed or utilized. The description sets forth the features of the present invention in connection with the illustrated embodiments. It is to be understood, however, that the same or equivalent functions and structures may be accomplished by different embodiments that are also intended to be encompassed within the spirit and scope of the invention. As denoted elsewhere herein, like element numbers are intended to indicate like elements or features.

### Keywords

Garbage Collection—algorithm used to pick the next best block to erase and rewrite

Pre-conditioning—filling an empty drive with host data, and consequently new write will trigger garbage collection tasks.

WORM—Write Once Read Many

Cold Storage—storage device in which the data in occasionally accessed by the Host

IOPS—Number of I/O operations per second

RAID—Redundant Array of Inexpensive Drives/Devices

DRAM—Dynamic Random Access Memory

SoC—System on a Chip

SSD—Solid State Drive

The SSD products are employed in a number of form factors and tuned for several different applications. An embodiment of the present invention is a power efficient method for executing data processing tasks inside a storage device in a WORM environment scheduling such tasks at the time data retention operation is needed by the storage device.

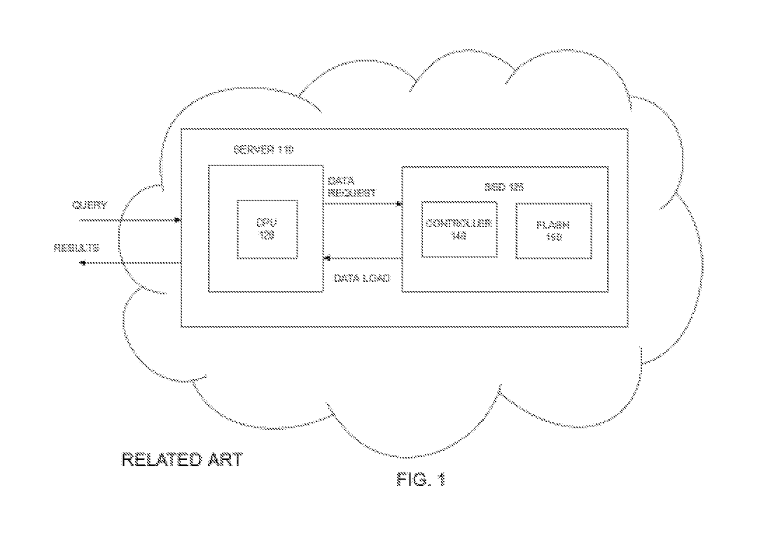

FIG. 1 shows a SSD device in communication with a host (Server 110). The Server 110 is part of a cluster of server executing map-reduce functions. The Server 110 receives a query, from a Master Node of the Cluster, to process data that is stored in the SSD 125. A SSD usually contains a controller 140 and the flash memory devices 150. The Server 110 sends a data request to the SSD 125, and then the data is transferred to the Server 110 to be processed by the CPU 120. This flow is a typical sequence of operation in a data center.

As shown in FIG. 1, in operation, the server 110 may receive a query, which may, for example, entail finding the number of occurrences of a certain pattern or text. As used herein, a pattern is a combination of strings and logical operations, in which the logical operations determine which combinations of the strings, if they are found in a set of data, will constitute a match for the pattern in the set of data. In response, the server 110 may send a data request to the comparable SSD 125. The comparable SSD 125 receives the data request, and retrieves the requested data. The comparable SSD 125 then sends the data to the server 110. The server CPU 120 processes the data and returns the results. The server 110 and the comparable SSD 125 may include additional components, which are not shown in FIG. 1 to simplify the drawing.

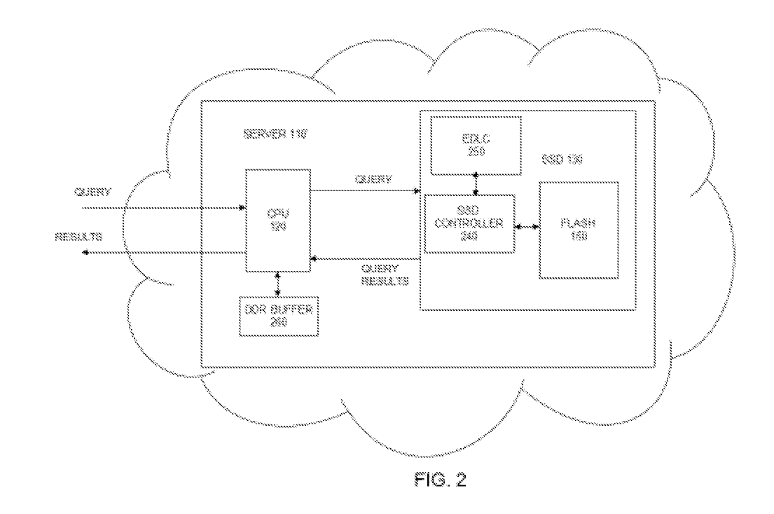

FIG. 2 shows an intelligent SSD 130 that has the capabilities of a comparable SSD 125 in addition to further capabilities discussed in detail below. Thus, an intelligent SSD 130 may be used in applications in which a comparable SSD 125 might otherwise be used, such as those described above with respect to FIG. 1.

In particular and as shown in FIG. 2, a server 110′ may include a processor, such as a server central processing unit (CPU) 120, and an intelligent SSD 130. The intelligent SSD may include an Environmental Data Logging System (EDLC) 250 to measure and store environmental data of the SSD to be used to estimate the time interval in which the Host can turn off the drive without affecting the data integrity. The EDLC 250 may include a real-time clock, a watchdog timer, a battery, one or more sensors, for instance, temperature sensor.

The server 110′ and intelligent SSD 130 may be implemented in a cloud-based computing environment. The server 110′ and intelligent SSD 130 may communicate using any storage buses as well as PCIe with any protocol which runs on it. In other embodiments storage nodes may be connected to, and controlled by, a host CPU which need not be a server CPU but may be a CPU in an application not configured as a server.

The server 110′ and the intelligent SSD 130 can be in communication with each other via a wired or wireless connection. For example, in one embodiment, the intelligent SSD 130 may comprise pins (or a socket) to mate with a corresponding socket (or pins) in the server 110′ to establish an electrical and physical connection with, e.g., the CPU 120. In another embodiment, the intelligent SSD 130 can comprise a wireless transceiver to place the server 110′ and the intelligent SSD 130 in wireless communication with each other. The server 110′ and the intelligent SSD 130 may be separately housed from each other, or contained in the same housing.

As shown in FIG. 2, in operation, the server 110′ may receive a query, described by map and reduce functions, for example, which may entail finding the number of occurrences of a certain pattern or text. As used herein, a pattern is a combination of strings and logical operations, in which the logical operations determine which combinations of the strings, if they are found in a set of data, will constitute a match for the pattern in the set of data. In response, the server 110′ may send a data request to the intelligent SSD 130. The intelligent SSD 130 receives the data request, and retrieves the requested data. The intelligent SSD 130 then sends the data to the server 110′. The server CPU 120 processes the data and returns the results.

FIG. 2 is a block diagram of a system which includes a server 110′ containing, and in communication with, an intelligent SSD 130 for performing data queries according to aspects of the present disclosure. The server 110′ and intelligent SSD 130 may be part of a cloud-based computing environment, a network, or a separate subsystem. The server may also contain a server CPU 120, and a data buffer 260, which may be composed of DDR memory.

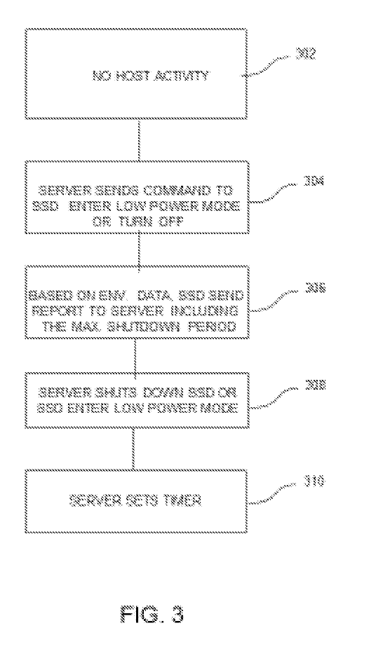

In case the intelligent SSD 130 is used in a “cold storage” environment (Write Once and Read Sporadically), the server 110′ may decide to turn off the storage or command the storage device to enter a power safe mode. FIG. 3 shows a mechanism to implement this procedure without affecting the data integrity of the storage device due to data retention failures. If there is no Host Activity, server 110′ may decide to turn off device to save power. Server 110′ sends a command to the SSD 130 to turn off or enter low power mode. The SSD 130, based on the information provided by the EDLC 250 sends a report to server 110′ including the maximum shutdown period that does not compromise the data integrity due to data retention problems. Server 110′ shuts down the SSD or sends a command to enter low power mode.

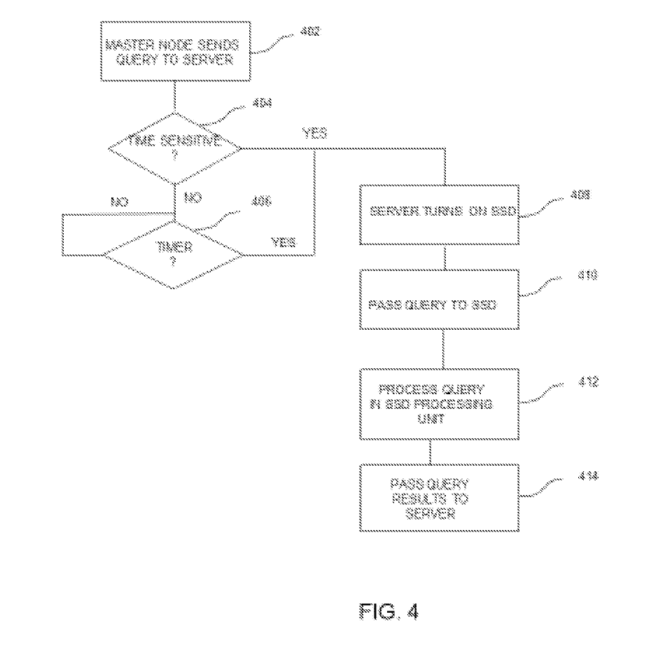

In one embodiment, The Host provides data processing tasks to the server 110′ and also provide information about if this data processing tasks are time sensitive. FIG. 4 shows the method and system to perform the data processing tasks in combination to the data retention operations.

Master Node sends a query to Server to perform a data processing task at step 402, Server checks if the task is time sensitive at step 404. If the task is time sensitive, Server turns on SSD at step 408. The intelligent SSD receives the query at step 410, and process the query at step 412. At step 414, it sends the result of the query to server. If the query is not time sensitive, server waits for the timer to expire at step 406; when timer expires, server turns on SSD at step 408. In this case, the intelligent SSD will perform the data processing task at same time it needs to perform the data retention operation and, consequently, saving power consumption.

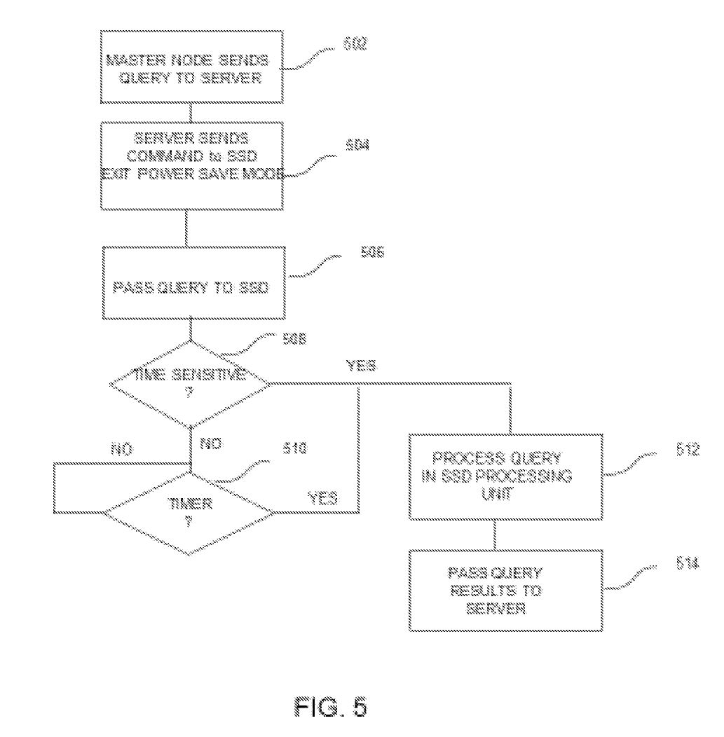

In another embodiment, the server sends the data processing tasks to SSD which is responsible for managing the scheduling of the tasks, as shown in FIG. 5. Host sends a query to server at step 502. At step 504, server sends a command to exit power saving mode and passes the query to SSD at step 506. SSD checks if the query is time sensitive at step 508. If query is time sensitive, it processes the query immediately at step 512. SSD sends the result to Server at step 514. If the query is not time sensitive, SSD waits for the data retention time to expire at step 510. If timer expires, SSD processes the query at step 512 and sends the result to server at step 514.

In one embodiment, the SSD accumulates a number of data processing tasks that are not time sensitive to be performed at same time, reducing the overall power consumption comparing to executing these tasks separately.

### Advantages/Benefits of Embodiments of Invention

An embodiment of the invention provides a mechanism to provide a lower power data processing execution combining the data processing to the data retention operations in a SSD.

1. A system utilizing this mechanism can minimize the system power consumption by merging data processing tasks and data retention operations inside the SSD.

2. The SSD can accumulate many processing tasks to reduce even more the overall power consumption by combining the data processing tasks.

### Feasibility/Proof of Concept/Results Demonstration

An embodiment of the invention can be simulated utilizing a model and demonstrate the benefits of its utilization. A SystemC model of a SSD will be modified to include the commands to manage the scheduling of the data processing tasks accordingly to the mechanism in this application (in the embodiment of the invention) and a comparison of a SSD with and without the embodiment of the invention will be provided.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section, without departing from the spirit and scope of the inventive concept.

Spatially relative terms, such as “beneath”, “below”, “lower”, “under”, “above”, ^{“}upper” and the like, may be used herein for ease of description to describe one element or feature's relationship to another element(s) or feature(s) as illustrated in the figures. It will be understood that such spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the terms “substantially,” “about,” and similar terms are used as terms of approximation and not as terms of degree, and are intended to account for the inherent deviations in measured or calculated values that would be recognized by those of ordinary skill in the art. As used herein, the term “major component” means a component constituting at least half, by weight, of a composition, and the term “major portion”, when applied to a plurality of items, means at least half of the items.

As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the inventive concept refers to “one or more embodiments of the present invention”. Also, the term “exemplary” is intended to refer to an example or illustration. As used herein, the terms “use,” “using,” and “used” may be considered synonymous with the terms “utilize,” “utilizing,” and “utilized,” respectively.

It will be understood that when an element or layer is referred to as being “on”, “connected to”, “coupled to”, or “adjacent to” another element or layer, it may be directly on, connected to, coupled to, or adjacent to the other element or layer, or one or more intervening elements or layers may be present. In contrast, when an element or layer is referred to as being “directly on”, “directly connected to”, “directly coupled to”, or “immediately adjacent to” another element or layer, there are no intervening elements or layers present.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein.

Although exemplary embodiments of a Power Efficient Method And System For Executing Host Data Processing Tasks During Data Retention Operations In A Storage Device have been specifically described and illustrated herein, many modifications and variations will be apparent to those skilled in the art. Accordingly, it is to be understood that a Power Efficient Method And System For Executing Host Data Processing Tasks During Data Retention Operations In A Storage Device constructed according to principles of this invention may be embodied other than as specifically described herein. The invention is also defined in the following claims, and equivalents thereof.

What is claimed is:

1. A method for operating a solid state drive (SSD) connected to a server, the SSD comprising nonvolatile memory and environmental data logging circuitry (EDLC), the method comprising:
requesting, by the host, a length of a first time interval from the SSD;
providing, by the SSD, the length of the first time interval to the host;
discontinuing, by the server, during the first time interval, a primary power supplied to the SSD;
restoring, by the server, of the primary power supplied to the SSD; and
providing, by the server, a query to be processed by the SSD and
refreshing of data stored in the SSD, by the SSD, when a module evaluated by the SSD indicates that, based on the logged environmental data, refreshing of the data is required.

2. The method of claim 1, wherein the environmental data comprises a temperature of the SSD.

3. The method of claim 2, wherein the environmental data comprises a time stamp.

4. The method of claim 1, comprising recording, by the SSD, a number of erase cycles performed on the nonvolatile memory.

5. The method of claim 1, wherein the Server accumulates queries to send at same time to the SSD after the first time interval.

6. A method for operating a solid state drive (SSD) connected to a server, the SSD comprising nonvolatile memory and environmental data logging circuitry (EDLC), the method comprising:
instructing, by the host, the SSD to transition to a sleep mode;
transitioning, by the SSD, to the sleep mode;
logging, by the EDLC, of environmental data at a plurality of points in time, while the SSD is in the sleep mode;
instructing, by the server, the SSD to transition to an active mode;
transitioning, by the SSD, to the active mode;
providing, by the server, a query to be processed by the SSD;
refreshing of data stored in the SSD, by the SSD, when a module evaluated by the SSD indicates that, based on the logged environmental data, refreshing of the data is required; and
sending, by the SSD, status information to the server, wherein the status information comprises a new sleep interval.

7. The method of claim 6, wherein the environmental data comprises a temperature of the SSD.

8. The method of claim 7, wherein the environmental data comprises a time stamp.

9. The method of claim 6, comprising recording, by the SSD, a number of erase cycles performed on the nonvolatile memory.

10. The method of claim 6, wherein the SSD accumulates queries to be processed after the first time interval.
